(19) United States
(12) Patent Application Publication
(10) Pub. No.: US 2011/0073009 A1
(43) Pub. Date: Mar. 31, 2011

(54) Moldable Matrix

(75) Inventors: Ching Wah Man, Hong Kong (CN); Lai Kit Lau, Hong Kong (CN)

(73) Assignee: LEADING CORPORATE LIMITED, Hong Kong (CN)

(21) Appl. No.: 12/994,757

(22) PCT Filed: Jun. 3, 2009
(86) PCT No.: PCT/IB2009/052341

§ 371 Date: Nov. 24, 2010

Related U.S. Application Data
(60) Provisional application No. 61/059,265, filed on Jun. 5, 2008.

(51) Int. Cl. C08L 1/08

(52) U.S. Cl. 106/204.01; 106/286.6; 106/286.3

(57) ABSTRACT

A moldable matrix comprises a mixture of magnesium chloride, magnesium oxide, sodium hexametaphosphate, and/or sodium pyrophosphate. The matrix can be used as an environmentally-friendly substitute to conventional construction material such as plastics and woods.

### FIELD OF INVENTION

This invention relates to a moldable matrix, and in particular, a moldable inorganic matrix.

### BACKGROUND OF INVENTION

In recent years, with the increasing consumption of petroleum, the resources thereof have been diminishing quickly, leading to the enormous rises in the petroleum prices. Consequently, the prices of petroleum by-products, such as plastics, have also been increasing drastically with that of petroleum. Apart from prices, there is also a growing concern in using plastics as construction materials due to its potential release of poisonous materials such as volatile organic compounds (VOCs), and the nature of its non-biodegradability.

Beside plastics, woods are also widely popular as construction materials, especially in the building industry. However, the excessive exploitation of woods not only destroys the natural habitant for thousands types of animals and plants, but also adversely affect the ecological system for human beings.

### SUMMARY OF INVENTION

In the light of the foregoing background, it is an object of the present invention to provide an alternate construction material.

Accordingly, the present invention, in one aspect, is a moldable matrix comprising a mixture of magnesium chloride, magnesium oxide together with sodium hexametaphosphate and/or sodium pyrophosphate. The moldable matrix may be obtained by admixing sodium hexametaphosphate and/or sodium pyrophosphate with magnesium chloride and magnesium oxide.

In another embodiment, the moldable matrix further comprises fiber, stabilizing agent, and iron (II) sulphate. In yet another embodiment, any two of the three aforesaid ingredients can be added to the moldable matrix.

The moldable matrix of the instant invention is not susceptible to mildew and not affected by humidity. The matrix according to the present invention is easily molded, manufactured and has good tensile strength.

### DETAILED DESCRIPTION OF THE PREFERRED EMBODIMENTS

As used herein and in the claims, “comprising” means including the following elements but not excluding others.

In one aspect of the present invention, the moldable matrix comprises magnesium chloride, magnesium oxide, sodium hexametaphosphate, and/or sodium pyrophosphate. In one embodiment, the moldable matrix further comprises fiber, stabilizing agent, and iron (II) sulphate.

In one embodiment, the fiber is glass fiber, rock fiber, and vegetal fiber (e.g. sisal fiber). The stabilizing agent is a polymer; in yet another embodiment, the polymer is a resin selected from methylcellulose, urea formaldehyde, and melamine formaldehyde. Further, iron (II) sulphate can be replaced by sulfuric acid (H₂SO₄) and iron (III) chloride (FeCl₃).

In another embodiment, the moldable matrix comprises magnesium chloride, magnesium oxide, glass fiber, methylcellulose, iron (II) sulphate, sodium hexametaphosphate, and sodium pyrophosphate. The composition of this embodiment of the invention is listed in Table 1 below. Example 1 provides a workable range while Example 2 discloses a more specific working range for each component of the moldable matrix according to the present invention.

TABLE 1

| | | EXAMPLE 1 | EXAMPLE 2 |
|---|---|---|---|
| | Ingredients | By weight % | By weight % |
| 1 | Magnesium chloride | 32-35 | 33-34 |
| 2 | Magnesium oxide | 60-63 | 61-62 |
| 3 | Glass fiber | 1-3 | 1.5-2.5 |
| 4 | Methylcellulose | 0.2-3.5 | 1-2 |
| 5 | Iron (II) sulphate | 0.2-3.5 | 1-2 |
| 6 | Sodium hexametaphosphate | 0.2-3.5 | 1-2 |
| 7 | Sodium pyrophosphate | 0.2-3.5 | 1-2 |

Since a mixture of magnesium chloride and magnesium oxide is relatively brittle, the stabilizing agent added is used to stabilize the matrix and most importantly and increase the tensile strength thereof. As a result, the endurance of the overall matrix will be greatly enhanced. Also, the fiber added is used to further reinforce the resultant matrix.

In yet another embodiment, different materials can be added to the moldable matrix as fillers to diversify the applications of the resulting matrix. In one embodiment, the amount of fillers added can be up to 30% by weight of the resulting matrix, with a proportionate reduction in magnesium chloride and magnesium oxide. The corresponding composition of this embodiment is listed in Table 2 below. Similar to the format of Table 1, there are two examples in Table 2 to respectively describe a workable range (i.e. Example 3), and a more specific workable range (i.e. Example 4) for each ingredient thereof.

TABLE 2

| | | EXAMPLE 3 | EXAMPLE 4 |
|---|---|---|---|
| | Ingredients | By weight % | By weight % |
| 1 | Magnesium chloride | 22-35 | 26-31 |
| 2 | Magnesium oxide | 40-63 | 48-58 |
| 3 | Glass fiber | 1-3 | 1.5-2.5 |
| 4 | Methylcellulose | 0.2-3.5 | 1-2 |
| 5 | Fillers | 1-30 | 5-20 |
| 6 | Iron (II) sulphate | 0.2-3.5 | 0.5-2 |
| 7 | Sodium hexametaphosphate | 0.2-3.5 | 0.5-2 |
| 8 | Sodium pyrophosphate | 0.2-3.5 | 0.5-2 |

In another aspect of the present invention, a method for preparing a moldable matrix is provided. In one implementation, the method for producing the moldable matrix having ingredients and corresponding compositions as shown in Table 1 includes the first step of admixing magnesium chloride, magnesium oxide, glass fiber, methylcellulose, iron (II) sulphate, sodium hexametaphosphate, and sodium pyrophosphate under ambient conditions. Then, the mixture is applied into a mold by hand and/or spray lay-up for gelatification and curing to obtain the cast.

The moldable matrix according to the instant invention can be used as raw materials for the manufacture of indoor and/or outdoor furniture or decorative items, and can also be applied in architectural moldings. Its application can further be extended to non-load bearing engineering products such as coverage panels, fitting out panels, ceiling tiles, and wood-substitute panels.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

For example, in one embodiment, the moldable matrix according to the present invention comprises magnesium chloride, magnesium oxide, and sodium hexametaphosphate, whereas in another embodiment, sodium hexametaphospate is replaced by sodium pyrophosphate for admixing with magnesium chloride and magnesium oxide to obtain the moldable matrix. The amounts of sodium hexametaphosphate or sodium pyrophosphate added vary under different experimental conditions such as humidity and temperature, and the added amounts are generally determined by one skilled in the art.

What is claimed is:

1. A moldable matrix comprising a mixture of magnesium chloride, magnesium oxide, sodium hexametaphosphate, and sodium pyrophosphate.

2. The moldable matrix according to claim 1 wherein said mixture further comprises fiber, stabilizing agent, and iron (II) sulphate.

3. The moldable matrix according to claim 2 wherein said fiber is selected from the group consisting of glass fiber, rock fiber, and vegetable fiber.

4. The moldable matrix according to claim 3 wherein said vegetable fiber is Agave sisalana.

5. The moldable matrix according to claim 2 wherein said stabilizing agent is polymer.

6. The moldable matrix according to claim 5 wherein said polymer is a resin selected from the group consisting of methylcellulose, urea formaldehyde, and melamine formaldehyde.

7. The moldable matrix according to claim 2 wherein said iron (II) sulphate can be replaced by sulfuric acid or iron (III) chloride.

8. The moldable matrix according to claim 2 further comprising
a) about 32 to 35 weight percent of said magnesium chloride;
b) about 60 to 63 weight percent of said magnesium oxide;
c) about 1 to 3 weight percent of said fiber;
d) about 0.2 to 3.5 weight percent of said stabilizing agent;
e) about 0.2 to 3.5 weight percent of said iron (II) sulphate;
f) about 0.2 to 3.5 weight percent of said sodium hexametaphosphate; and
g) about 0.2 to 3.5 weight percent of said sodium pyrophosphate.

9. The moldable matrix according to claim 2 or 8 further comprising
a) about 33 to 34 weight percent of said magnesium chloride;
b) about 61 to 62 weight percent of said magnesium oxide;
c) about 1.5 to 2.5 weight percent of said fiber;
d) about 1 to 2 weight percent of said stabilizing agent;
e) about 1 to 2 weight percent of said iron (II) sulphate;
f) about 1 to 2 weight percent of said sodium hexametaphosphate; and
g) about 1 to 2 weight percent of said sodium pyrophosphate.

10. The moldable matrix according to claim 2 wherein said mixture further comprises fillers such that the concentration of
a) said magnesium chloride ranges from about 22 to 35 weight percent of said matrix;
b) said magnesium oxide ranges from about 40 to 63 weight percent of said matrix;
c) said fiber ranges from about 1 to 3 weight percent of said matrix;
d) said stabilizing agent ranges from about 0.2 to 3.5 weight percent of said matrix;
e) said fillers range from about 1 to 30 weight percent of said matrix;
f) said iron (II) sulphate ranges from about 0.2 to 3.5 weight percent of said matrix;
g) said sodium hexametaphosphate ranges from about 0.2 to 3.5 weight percent of said matrix; and
h) said sodium pyrophosphate ranges from about 0.2 to 3.5 weight percent of said matrix.

11. The moldable matrix according to claim 10 wherein the concentration of
a) said magnesium chloride ranges from about 26 to 31 weight percent of said matrix;
b) said magnesium oxide ranges from about 48 to 58 weight percent of said matrix;
c) said fiber ranges from about 1.5 to 2.5 weight percent of said matrix;
d) said stabilizing agent ranges from about 1 to 2 weight percent of said matrix;
e) said fillers range from about 5 to 20 weight percent of said matrix;
f) said iron (II) sulphate ranges from about 0.5 to 2 weight percent of said matrix;
g) said sodium hexametaphosphate ranges from about 0.5 to 2 weight percent of said matrix; and
h) said sodium pyrophosphate ranges from about 0.5 to 2 weight percent of said matrix.

12. The moldable matrix according to claim 1 wherein said mixture further comprises glass fiber, methycellulose, and iron (II) sulphate.

13. The moldable matrix according to claim 12 further comprising
a) about 32 to 35 weight percent of said magnesium chloride;
b) about 60 to 63 weight percent of said magnesium oxide;
c) about 1 to 3 weight percent of said glass fiber;
d) about 0.2 to 3.5 weight percent of said methylcellulose;
e) about 0.2 to 3.5 weight percent of said iron (II) sulphate;
f) about 0.2 to 3.5 weight percent of said sodium hexametaphosphate; and
g) about 0.2 to 3.5 weight percent of said sodium pyrophosphate.

14. The moldable matrix according to claim 13 further comprising
a) about 33 to 34 weight percent of said magnesium chloride;
b) about 61 to 62 weight percent of said magnesium oxide;
c) about 1.5 to 2.5 weight percent of said glass fiber;
d) about 1 to 2 weight percent of said methylcellulose;
e) about 1 to 2 weight percent of said iron (II) sulphate;
f) about 1 to 2 weight percent of said sodium hexametaphosphate; and
g) about 1 to 2 weight percent of said sodium pyrophosphate.

15. The moldable matrix according to claim 12 further comprising fillers such that the concentration of
a) said magnesium chloride ranges from about 22 to 35 weight percent of said matrix;
b) said magnesium oxide ranges from about 40 to 63 weight percent of said matrix;
c) said glass fiber ranges from about 1 to 3 weight percent of said matrix;
d) said methycellulose ranges from about 0.2 to 3.5 weight percent of said matrix;
e) said fillers range from about 1 to 30 weight percent of said matrix;
f) said iron (II) sulphate ranges from about 0.2 to 3.5 weight percent of said matrix;
g) said sodium hexametaphosphate ranges from about 0.2 to 3.5 weight percent of said matrix; and
h) said sodium pyrophosphate ranges from about 0.2 to 3.5 weight percent of said matrix.

16. The moldable matrix according to claim 15 further comprising
a) said magnesium chloride ranges from about 26 to 31 weight percent of said matrix;
b) said magnesium oxide ranges from about 48 to 58 weight percent of said matrix;
c) said glass fiber ranges from about 1.5 to 2.5 weight percent of said matrix;
d) said methylcellulose ranges from about 1 to 2 weight percent of said matrix;
e) said fillers range from about 5 to 20 weight percent of said matrix;
f) said iron (II) sulphate ranges from about 0.5 to 2 weight percent of said matrix;
g) said sodium hexametaphosphate ranges from about 0.5 to 2 weight percent of said matrix; and
h) said sodium pyrophosphate ranges from about 0.5 to 2 weight percent of said matrix.
